(19) United States
(12) Patent Application Publication
(10) Pub. No.: US 2003/0191716 A1
(43) Pub. Date: Oct. 9, 2003

(54) Secure storage system and method

(75) Inventors: Stephen Robert Woods, Hampshire (GB); Philip Carl Charette, Ipswich, MA (US)

Correspondence Address: OSTROLENK FABER GERB & SOFFEN, 1180 AVENUE OF THE AMERICAS, NEW YORK, NY, 100368403

(73) Assignee: Solarsoft Ltd.

(21) Appl. No.: 10/120,131

(22) Filed: Apr. 9, 2002

(51) Int. Cl. G06F 17/60

(52) U.S. Cl. 705/50

(57) ABSTRACT

A secure storage system and method comprises setting up a storage area for storing encrypted files in a store accessible via the Internet and generating user specific user interface code requiring the entry of a user password during execution on a user's computer for access to the encrypted files in the store over the Internet. The generated user specific user interface code is stored at a site accessible via the Internet for download by a user. A user can thus use a computer to download the user specific user interface code and enter their password in order to be able to access the encrypted files. Preferably, the files are encrypted using a password which is the same as the user password required to be entered to activate the user interface. Thus in this way the user interface is able to decrypt the files in a simple manner which can be automated.

### FIELD OF THE INVENTION

The present invention generally relates to a secure storage system and method for securely storing files in encrypted form and for allowing a user access to the files via the Internet.

### BACKGROUND OF THE INVENTION

With the prevalent use of computers in the business world, heavy reliance is placed on the security of data and the easy availability of such data.

With the growth of the Internet it has been realized that it is possible to provide storage on a server which is available to a user over the Internet. Users are thus able to pay for storage space which they can access from anywhere via the Internet. One major issue with such a system is, however, inherent security of such a system.

An object of the present invention is to provide a secure storage system and method which provides for secure access to files in a storage area within the requirement for security software on the user's computer.

### SUMMARY OF THE INVENTION

In accordance with one aspect, the present invention provides a secure storage system and method in which encrypted information, e.g. data files, program files, or any other type of information can be stored in a secure storage area which is accessible over the Internet. User specific user interface code is generated and stored at a location which is accessible to a user over the Internet. The user specific user interface code is user specific since it requires the entry of a user password during execution on a computer. During execution of the user specific user interface code, and upon entry of the correct user password, the interface provides access to the encrypted information in the storage area over the Internet.

Thus in accordance with this aspect of the present invention, a user is able to gain access to encrypted information, i.e. files, by downloading the user specific user interface code, executing the code, and entering a correct user specific password. This will activate the code and allow the user access to the encrypted files. Thus this aspect of the present invention is secure since the user interface code is required in order to access the secure storage area. This is available to a user using any computer connected to the Internet and can be downloaded. Security is assured by requiring a user password in order for the interface code to execute.

The encrypted files can be stored on the storage area using any means by which secure access can be obtained to the storage area. In one embodiment a similar user interface to the downloadable user specific user interface is provided on a user's own computer, i.e. a computer that they usually use and which is configured for their own use. Thus in this way the storage area acts as a means by which they can securely back up their files. A user interface can be provided to allow access to the storage area from the user's usual computer to allow them to upload encrypted files for safe storage in case of loss or theft of the user's usual computer. It is when the user's usual computer is lost or stolen that the present invention is particularly useful. Since the user has lost their usual means of accessing the storage area securely, they require another way of accessing the encrypted files in the storage area securely. In order to do this, a user can make use of any other computer connected to the Internet to connect to a site holding the user specific user interface code and download the code onto the user's temporary computer. By entry of the user's password, the user specific user interface is activated to allow the user access to the encrypted files in the storage area. In a preferred embodiment, the user specific user interface provides for conventional file manipulation, i.e. uploading and downloading of files, and deletion of files in the storage area. Files which are uploaded are uploaded in encrypted form and files which are downloaded can be automatically decrypted, or stored in encrypted form for later decryption.

In a preferred embodiment of the present invention, the method of encryption uses the user's password as the encryption key. Thus the encrypted files are user specifically encrypted. In this preferred embodiment, symmetric key encryption is used thereby allowing decryption using the same user password. Thus the user password used to activate the user specific user interface code can also be used for the decryption of the encrypted files. This decryption can be selected by the user when implementing the user interface to take place automatically upon download of files. Alternatively, the user interface can allow later decryption of downloaded files which are stored on the user's temporary computer.

When a user wishes to take advantage of this secure storage system, they can register for the service. The registration data is received at a registration server whereupon a storage area is assigned for the user and user specific user interface code is generated for the user. The data required for registration includes the user password and security information to access the secure area. In a preferred embodiment the accessing is carried out using the file transfer protocol (FTP). In this case the information required for secure access to the storage area is the location of the storage area, the user name, and a password. This password is different to the password for activating the user specific user interface and for decrypting the files. It can, however, be the same password but it performs a different function. The registration data will also need to include Internet service provider data which includes the telephone number to dial up the Internet service provider, and the log on data to log onto the Internet service provider. In order to avoid users having to have their own Internet service provider, the service can include its own Internet service provider to provide access to the secure storage areas. The log in information for the Internet service provider, i.e. the user name and password, can be the same as that used for secure FTP access to the storage area.

One method by which the registration process can be carried out is by installation of software onto the user's usual computer. The installation process can include an authentication process to ensure that the software is a legitimate copy purchased from the service provider for registration purposes. During the installation process the user can be asked to enter the necessary registration information. The software can then automatically connected to the registration server to perform the registration process. This will set up the secure storage area for the user and will cause the generation of the user specific user interface. The software installed by the user will also provide the user with a user interface to their secure storage area for secure back up of data in the storage area.

When a user wishes to access their secure storage area from another computer, e.g. when their usual computer has been lost or stolen, or when they are away from their usual computer, the downloaded user specific user interface is installed on the user's temporary computer. If a user is only temporarily using the computer, it is desirable that the user specific user interface code and any data downloaded onto the user's temporary computer be deleted. In one embodiment of the present invention the user specific user interface code includes the ability to delete itself and/or any data files downloaded onto the user's temporary computer. A user can select to implement this feature when the user specific user interface code terminates execution, i.e. the application is closed. The deletion performed is a secure deletion by overwriting of the storage area on the hard disk to ensure that the code and/or the data can never be read following deletion.

In one embodiment of the present invention, for ease of use, when the service is set up for a user, a web page is generated in the storage area. A user will thus know the location of the storage area and can thus point their web browser to this area in order to access the web page. The web page includes a link to the location of the user specific user interface code so that this can be automatically downloaded by clicking on the link.

In one embodiment of the present invention, the size of the storage area available to the user is of a predetermined limited size. Thus in one embodiment of the present invention the user specific user interface includes an indicator of the available capacity in the storage area. This can be achieved by monitoring the uploading of files into the storage area the deletion of files in the storage area. Conventional downloading of files need not be monitored since the downloading will not remove the original copy of the file in the storage area. The available capacity in the storage area can thus be determined as files are moved to and from the storage area.

It can be seen that since the present invention is implemented by a network of computers networked via the Internet, the present invention encompasses the execution of code on a computer used by a user, a computer performing the service generation process, i.e. the setting up of the storage area and the generation of the user specific user interface code, and the computer providing the storage area. The present invention thus encompasses any such computer used in the implementation of the present invention.

The present invention is preferably implemented on computers executing computer code. Computer code can be provided to the computers by any suitable carrier medium. A suitable carrier medium can be a storage medium such as a floppy disk, hard disk, CD-ROM, or programmable memory device, or a transient medium such as an electrical, optical, microwave, or acoustic signal (e.g. a signal carrying computer code over a computer network such as a TCP/IP signal carrying computer code over the Internet).

### BRIEF DESCRIPTION OF THE DRAWINGS

FIG. 1 is a schematic diagram of the secure storage system in accordance with an embodiment of the present invention;

FIG. 2 is a schematic diagram of the user's laptop computer in the embodiment of FIG. 1;

FIG. 3 is a schematic diagram of the vault server in the embodiment of FIG. 1;

FIG. 4 is a flow diagram illustrating the insulation and registration process in accordance with an embodiment of the present invention;

FIG. 5 is a schematic diagram of the user interface in accordance with an embodiment of the present invention showing selection of a file for upload to the secure storage area;

FIG. 6 is a schematic diagram of the user interface following the uploading of the file to the secure storage area showing the content of one directory of the storage area in accordance with an embodiment of the present invention;

FIG. 7 is a flow diagram illustrating the operation of the user interface in accordance with an embodiment of the present invention;

FIG. 8 is a flow diagram illustrating the process for downloading and executing the user interface on a temporary computer by a user; and

FIG. 9 is a schematic diagram of the user's temporary computer after download of an installation of the user specific user interface code.

### DESCRIPTION OF PREFERRED EMBODIMENTS

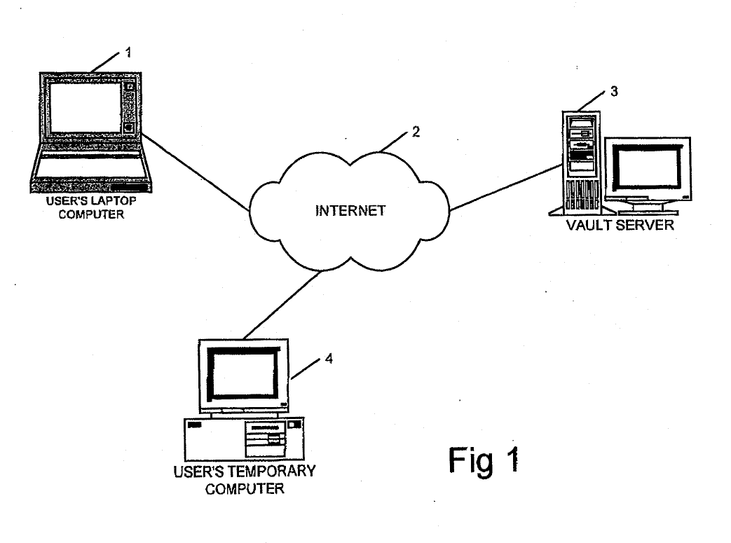

FIG. 1 is a schematic diagram illustrating in outline an embodiment of the present invention which will be described in more detail hereinafter in which a user usually uses a laptop 1 as their normal computer. The laptop 1 has a means by which it can access the Internet, e.g. a network card, or modem. A vault server 3 is available over the Internet and hosts the secure storage service. In this embodiment a user also has access temporarily to another computer 4, e.g. when their laptop is lost, stolen, or breaks down, or when they are temporarily away from their computer 1. The user's temporary computer 4 also has means by which it can connect to the Internet 2, e.g. network card, or modem for dial-up access.

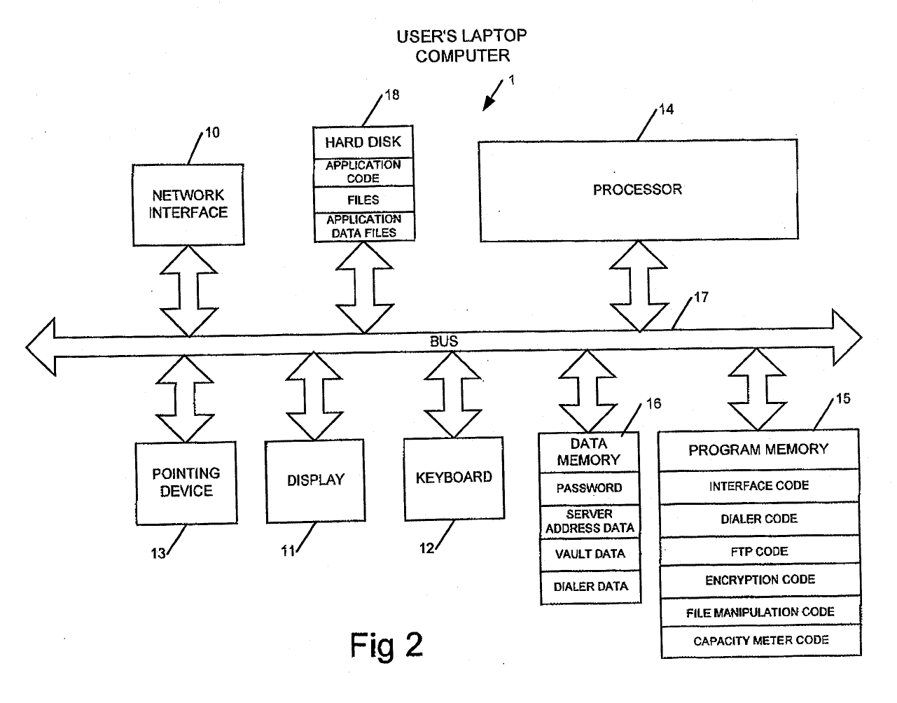

FIG. 2 is a schematic diagram of the user's laptop computer following installation of the secure storage application for normal use by the user to access the service hosted by the vault server 3.

The computer 1 comprises a network interface 10 such as a network card for local area network access, a digital subscriber line adapter, or a modem for dial-up access. A hard disk 18 stores files and data used by the user and by the application. It stores the secure storage application code, files used by the user, and application data files used by the secure storage application. The user's files can comprise any files such as Microsoft Word documents, presentation files, spreadsheets, or image files. The application data files store the data securely and secretly to avoid unauthorized access. The data includes data required to access the network. Where the network interface 10 is a modem, dialler data is needed including telephone number and user name and password for accessing an Internet service provider. In order to access the storage area, server access data is stored. This includes the host name of the server hosting the secure storage area and the user name and password for accessing the secure storage area. In this embodiment of the present invention, these comprise parameters used by the file transfer protocol (FTP) module for FTP transfer of data to and from the storage area.

The computer 1 also includes a pointing device 13 such as a mouse to allow a user to interface to the computer. A display 11 is provided to provide a visual output to allow the computer to interface to the user. Further, a keyboard 12 is provided to allow for user interface. A data memory 16 comprising volatile memory, i.e. RAM, stores data used by the application during execution. This data includes the user password, the server address data, the dialler data, and the vault data. The vault data includes all information on the configuration of the secure storage area (termed “the vault”). This includes the available capacity, the folders or directory names and file names, sizes and locations. This information is held in volatile memory since it is determined every time the user's interface is generated by accessing the storage area (the vault).

The computer 1 also includes a program memory 15 which comprises volatile memory storing program code which is used by a processor 14 to execute the application. The application code stored in the program memory 15 can be considered in this embodiment to be comprised of six functional code modules: interface code for generating the user interface, dialler code for controlling the modem to connect to the Internet, FTP code for performing FTP commands and FTP transfers of files, encryption code for performing encryption and decryption of files using the user password as the key for both encryption and decryption, file manipulation code for allowing files to be manipulated both locally and remotely in the secure storage area, and capacity meter code for dynamically determining the current capacity in the secure storage area and for generating capacity information for use by the interface code in generating the user interface.

All the components of the computer 1 are interlinked by the control and data bus 17.

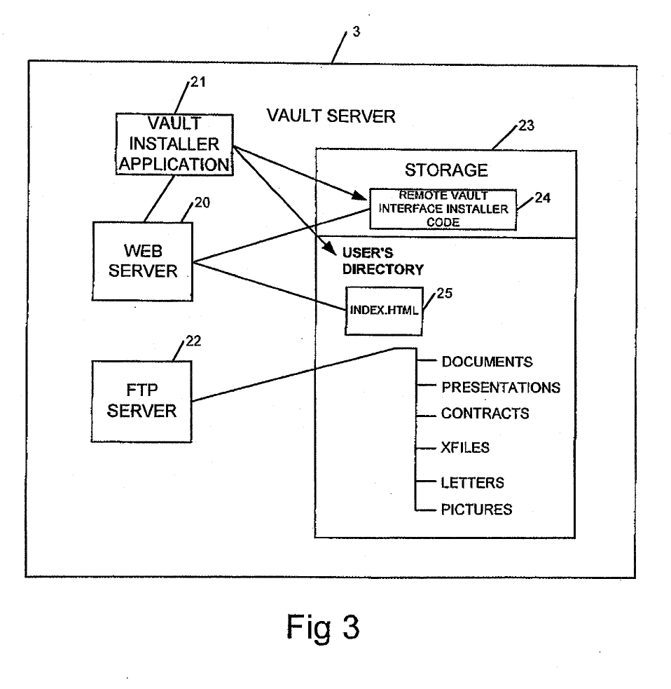

The structure of the vault server 3 will now be described with reference to FIG. 3. In this embodiment of the present invention the vault server 3 performs both the registration process and the secure storage area service. However, it is possible for these two functions to be performed by different servers.

In this embodiment of the present invention a storage device 23 is provided for storing users' directories which comprise the secure storage areas for users. Each user is assigned a user's directory into which is stored an index.html file 25 to act as a web interface. The user's directory also includes sub-directories or folders for the storage of encrypted files by the user. In this embodiment there are six folders or sub-directories headed: Documents, Presentations, Contracts, X Files, Letters and Pictures.

The storage device 23 also contains in this embodiment the remote vault interface installer code 24 (i.e. the user specific user interface code).

A file transfer protocol (FTP) server 22 is provided which is accessible over the Internet for controlling access to the folders or sub-directories within the user's directory. The FTP server 22 provides secure access since, as is well known for FTP servers, a user name and password is required to access a directory.

A web server 20 is also provided for accessing the index.html file 25 in each user's directory to provide a web interface. The index.html file 25 can be accessed by a web browser executed on the user's temporary computer in order to enable them to select to download the remote vault interface installer code 24 in the storage device 23.

A vault installer application 21 is also provided for performing the registration process. The vault installer application 21 will receive registration parameters from a user during the installation of the secure storage application. The vault installer application 21 will then set up the storage area by creating a user's directory and a number of folders or sub-directories with default labels. Also, the vault installer application 21 will generate the remote vault interface installer code 24 (i.e. the user specific user interface code).

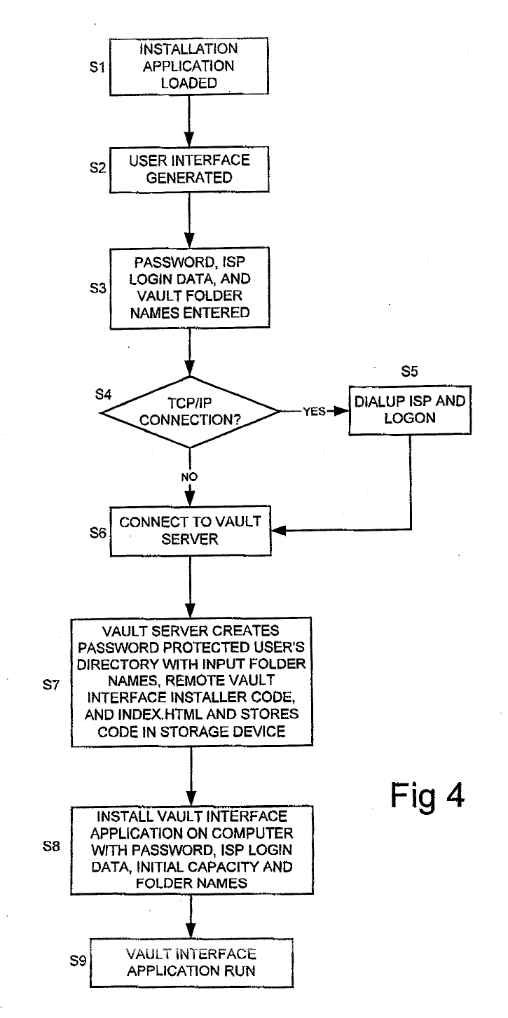

The operation of the secure storage application will now be described with reference to FIGS. 4 to 7.

FIG. 4 is a flow diagram illustrating the installation of the secure storage application and the registration process for registration of a user for the secure storage service.

A user is provided with a secure storage application installation package and in step S1 this is loaded into the computer, e.g. on a CD-ROM or floppy disk. The installation application generates a user interface (step S2). The user interface requires the input of registration parameters. These include:

1. A user password selected and input by a user.

2. Internet service provider (ISP) log in data. This data includes the telephone number for dial-up access, the user name and password for connection to the ISP. In order to avoid a user having to already have (or find) an ISP, the service can automatically provide an ISP for accessing the service. Thus this data can be set to the default ISP log in data and need not be modified or entered by a user.

3. Vault folder names. The names of the folders in the vault can be chosen by a user. For example, in this embodiment the user can select the folders to be: Documents, Presentations, Contracts, X Files, Letters and Pictures. After the data is entered by the user using the user interface (step S2) the application determines whether there is already a transmission control protocol/Internet protocol (TCP/IP) connection, i.e. an Internet connection (step S4). If so, the installation application makes a connection to the vault server 3, and specifically to the vault installer application 21 (step S6). If there is no TCP/IP connection, i.e. no Internet connection (step S4) the dialler code controls the modem to use the ISP log in data to dial-up the ISP and log on (step S5). Once a TCP/IP connection is made to the ISP, a connection is then made to the vault server 3 (step S6) and more specifically a connection is made to the vault installer application 21. The vault installer application 21 in the vault server 3 then creates the password protected users' directories with the input folder names. Also, the vault installer application 21 generates the remote vault interface installer code 24 and stores it in the storage device 23. Further, the index.html file 25 is generated and stored in the user's directory. The index.html file comprises a standard html template with a link to the user's specific remote vault interface installer code (step S7). Thus at this point a user has been registered for the service and the vault server 3 is configured for the service.

The installation application then installs the vault interface application onto the user's laptop computer 1 with the password, ISP log in data, initial capacity and vault folder names (step S8). The vault interface application then executes to generate the user interface (step S9). The vault interface will use volatile data stored in the data memory 16.

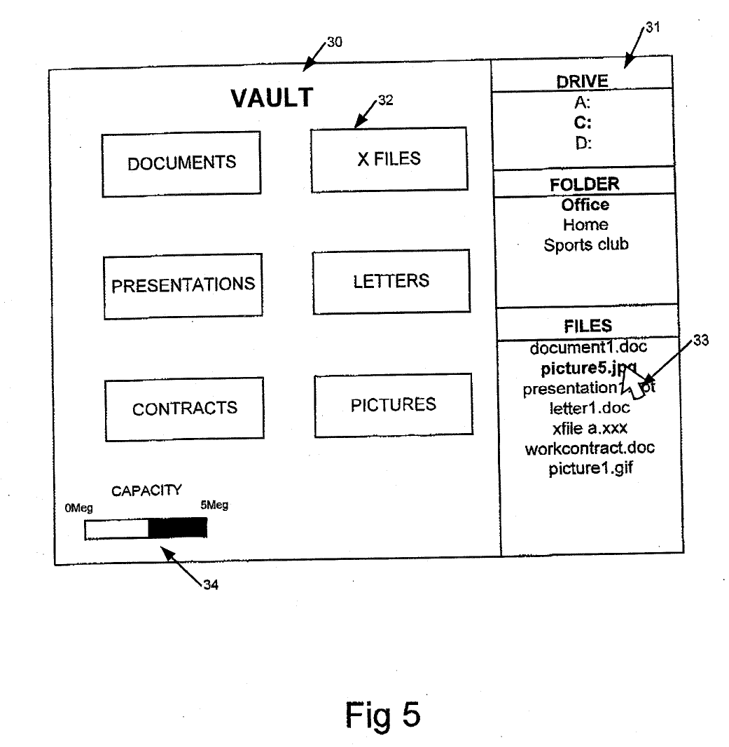

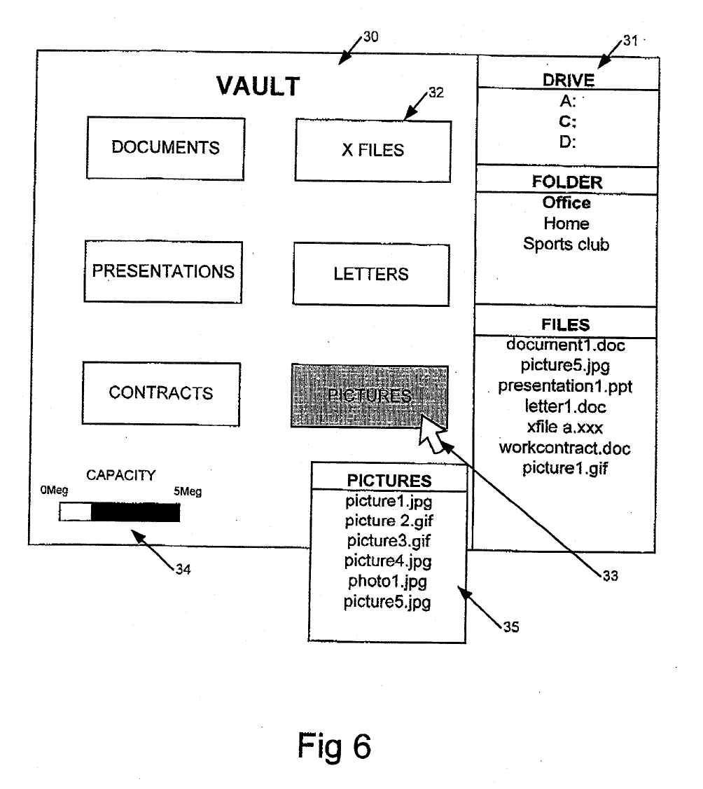

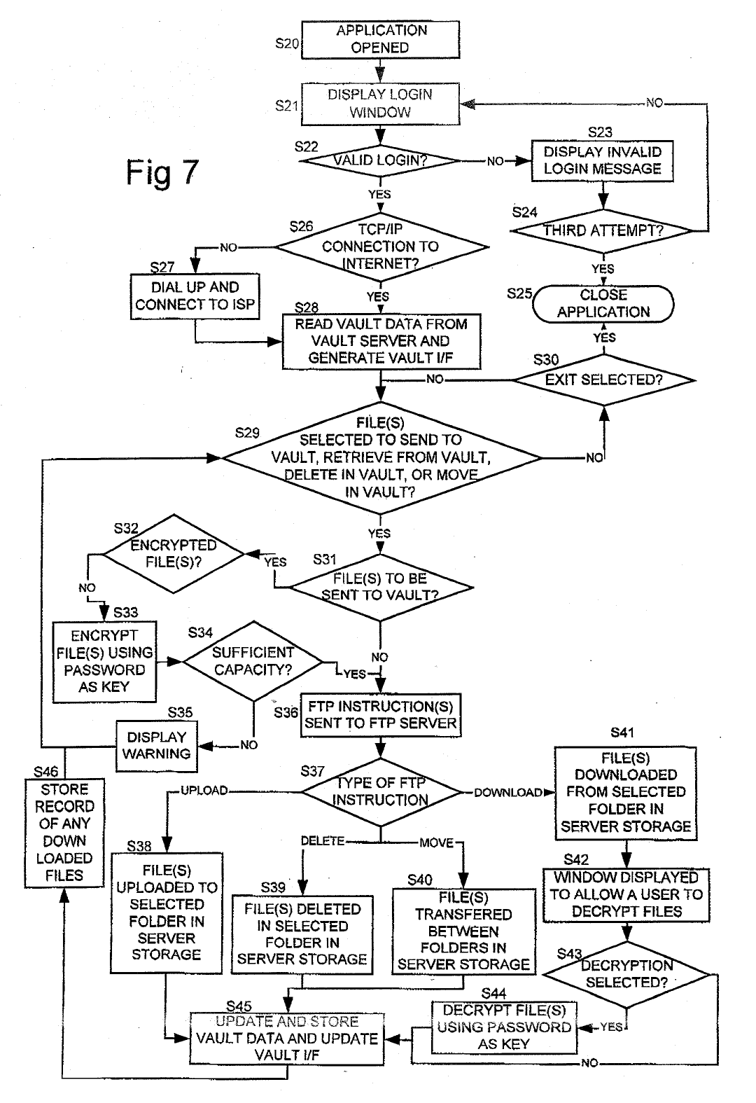

FIG. 5 is a schematic diagram of the user interface. The user interface is comprised of two parts: a vault interface showing data related to the vault (i.e. the remote storage area) and an area 31 showing parameters related to local storage on a user's laptop computer 1. As can be seen in FIG. 5, in this embodiment the vault display 30 displays six folders 32 labelled Documents, Presentations, Contracts, X Files, Letters and Pictures, respectively. Also there is shown a capacity meter 34 indicating the storage capacity left in the vault. In the area 31 showing the parameters related to local storage, the local drive selected is indicated, which in this case is C:. Also the local folder selected is indicated which in this case comprises Office. Files within the selected folder can be selected using the pointer 33 and in this case the file Picture 5.JPG has been selected. Using the conventional Microsoft Windows (trade mark) operation this file can be dragged and dropped into the Pictures folder. This operation is illustrated in FIG. 6 which shows the interface after the file Picture 5.JPG has been dragged and dropped into the Pictures folder. The pointer 33 has been used to open the folder Pictures to display a window 35 showing the contents in the folder. As can be seen the file Picture 5.JPG has been copied or uploaded to the vault. Since a file has been uploaded to the vault, the capacity meter 34 has been updated to show that the capacity available in the vault has decreased. The operation of the vault interface, i.e. the user interface will now be described in more detail with reference to the flow diagram of FIG. 7.

Once the application is opened (step S20) a log in window is displayed to allow a user to enter their password. Preferably the password does not simply comprise a password but rather a pass phrase. This increases the number of characters, thus increasing the level of security. A log in validation occurs (step S22). If it is determined that the entered password is invalid an invalid log in message is displayed (step S23). If this is the third unsuccessful log in attempt (step S24) the application is closed (step S25). If not, the log in process returns to display the log in window again (step S21).

Once a user has successfully logged in by entering their password (step S22) the application determines whether there is a TCP/IP connection to the Internet (step S26). This may be because the user is already connected to an ISP via their modem, or because they have a local area network connection. If a TCP/IP connection is already available (step S26), the FTP code in the application uses the FTP data to connect it to the FTP server 22 in the vault server 3 to read the vault data, i.e. the user's directory structure (folder names and file names and sizes) to enable the application to generate the vault interface (step S28). If the application does not detect a TCP/IP connection (step S26), the dialler code in the application controls the modem to use the ISP log in data to dial-up and connect to the ISP (step S27). Once a TCP/IP connection is made to the ISP (step S27) vault data can be read from the vault server 3 by the FTP code in the application making an FTP connection to the FTP server 22 in the vault server 3. The vault interface can then be generated using the vault data. Thus the application initially connects to the vault server in order to determine the correct vault structure to generate a correct vault interface. This is important since, as will be described in more detail hereinafter, it is possible for a user to use a temporary computer in order to access the vault and modify the content of the vault using a different computer. If the vault application on the user's laptop computer 1 did not connect each time it executed, it would have out-of-date information on the vault, i.e. it would not be synchronized. When the vault interface is generated as illustrated in FIG. 5, a user can select to send or upload files to the vault, to retrieve or download files from the vault, to delete files in the vault, or to move files within the vault from folder to folder (step S29). This can be performed simply by conventional dragging and dropping operations as illustrated and described with reference to FIGS. 5 and 6. If a user makes such a selection, if files are to be sent or uploaded to the vault (step S31) the application determines whether the selected file or files are encrypted (step S32). If not, the encryption code within the application uses the password as an encryption key to perform symmetric key encryption using Blowfish 448 bit encryption. Before an encrypted file is uploaded to the vaults, its file size is compared to the capacity available in the vault as determined by the capacity data (step S34). If the vault has insufficient capacity, a warning is displayed (step S35) which can include information informing the user how to purchase more storage space from the service provider. The process will then return to step S29 to await another selection by a user. If there is sufficient capacity in the vault to store the selected encrypted file or files (step S34) or if a user did not select to send (upload) files to the vault, FTP instructions are sent to the FTP server 22 in the vault server 3 to perform the selected file transaction (step S36). If the user selected to upload a file to the vault, the type of FTP instruction (step S37) is the upload instruction together with the file and this causes the uploading of the files to the selected folder in the storage device (step S38). If the selection was the deletion of a file in the vault, the type of FTP instruction (step S37) is a deletion and the selected file is deleted in the selected folder in the storage device (step S39). If the user selected to transfer a file between folders, the type of FTP instruction (step S37) is a move instruction which causes the transference of file between folders in the storage device (step S40). If a user selected to download a file from the vault, the type of FTP instructions (step S37) is a download instruction and this causes the file to be downloaded from the selected folder in the storage device to the user's laptop computer 1 (step S41). A window is then displayed in the vault interface to allow a user to select whether or not to decrypt the files downloaded (step S42). If a user selects to decrypt the files (step S43) the user's password is used as the key for decryption of the selected downloaded files (step S44).

After having performed either the upload, deletion, moving, or downloading of files, the vault data stored in the user's laptop computer 1 is updated and this is used to update the vault interface (step S45). In this way the displayed vault interface reflects the content of the vault, i.e. the content of the secure storage area. The updating comprises the updating of the names and sizes of files in the various folders. Also the capacity meter must be updated based on any uploaded or deleted files which changes the capacity available for storage of files in the vault.

It can thus be seen from the embodiment described hereinabove, that a user can register for the secure storage service and can securely store data on a remote storage device in encrypted form which is only accessible using the vault interface.

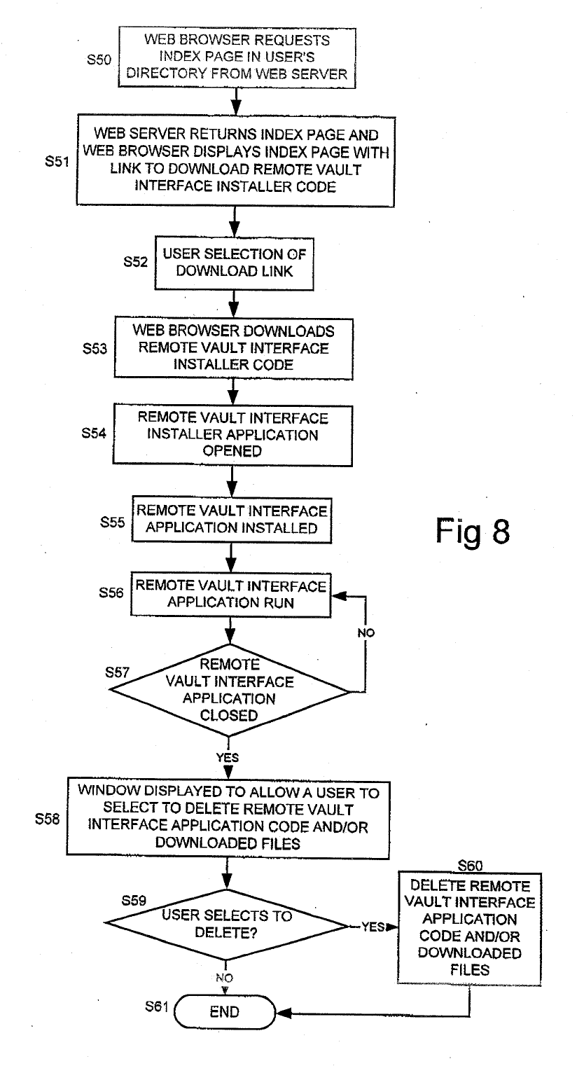

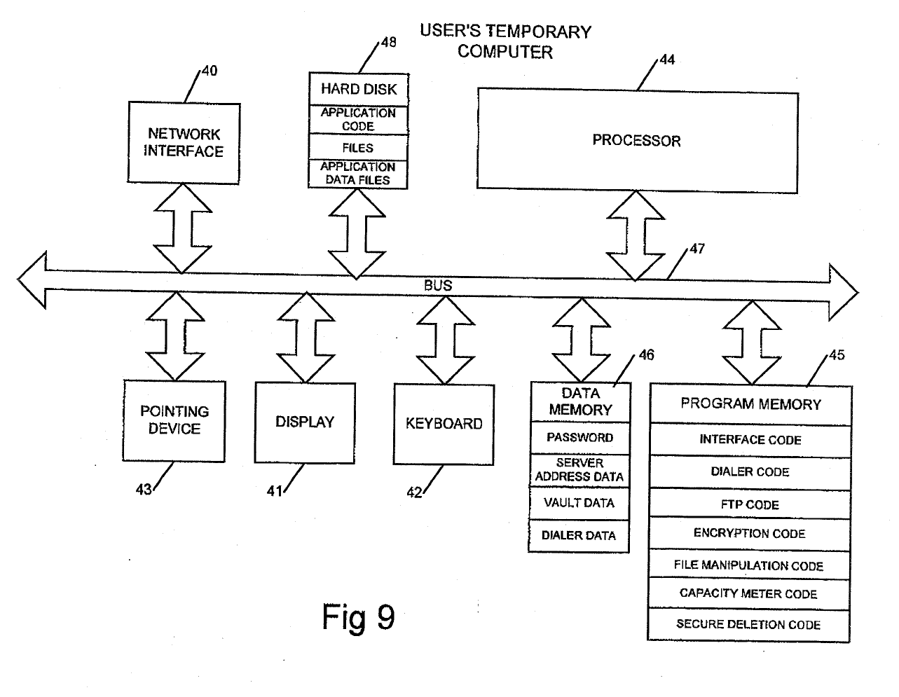

So far accessing of the secure storage area has only been described with reference to the application code stored on the user's usual computer. Whilst this provides a useful secure back-up service, this embodiment of the present invention also provides a far more useful service for secure back-up which does not require original software and which can be accessed from anywhere which provides Internet access. The method of accessing the secure storage area, i.e. the vault without using the user's laptop computer will now be described with reference to FIGS. 8 and 9. FIG. 8 is a flow diagram illustrating the process of downloading and setting up a user's temporary computer for accessing the secure storage area, i.e. the vault. FIG. 9 is a schematic diagram of the structure of the user's temporary computer 4 once configured with the installed code.

Referring to FIG. 8, when a user uses the user's temporary computer 4 because, for example, the user's laptop computer has been lost, stolen or damaged, or because a user is away from access to the laptop 1, a user can use any computer which has Internet access and which has a web browser to use the temporary computer 4 with the web browser to request the index page 25 in the user's directory from the web server 20 at the vault server 3. A user need only remember the location of their user's directory which can, for example, reside at a memorable URL such as www.username.vault.com. The web server 20 returns the index page and the web browser displays the index page with the link to download the remote vault interface installer code 24 from the storage device 23 (step S51). A user can then select the download link in the index page (step S52) and the web browser downloads the remote vault interface installer code 24 to the user's temporary computer 4 (step S53). The remote vault interface installer application can then be opened by the user on the user's temporary computer 4 (step S54) and the remote vault interface application will then be installed (step S55). The user can then run the remote vault interface application (step S56). The remote vault interface application will generate the vault interface which in this embodiment is the same as the vault interface generated in the secure storage application, i.e. that illustrated in FIGS. 5 and 6 and described with reference to the flow diagram of FIG. 7. Thus a user is able to perform all of the functions that they would have been able to perform on their normal computer, i.e. their laptop computer 1. It does however require them to enter their password in order for the application to run. Thus, in order to access the files in the secure storage area it is necessary to obtain the remote vault interface application code and to know the password in order to make it run. Since the files are encrypted in the storage area, even if someone is able to gain access to the storage area, they only gain access to encrypted files.

Once the remote vault interface application is closed (step S57) a window is displayed to allow a user to select to delete the remote interface application code and/or downloaded files (step S58). If a user selects to delete (step S59) the remote vault interface application code running in volatile memory deletes the code stored on the hard disk and/or any downloaded files stored on the hard disk (step S60). The deletion performed is a secure deletion in which the sectors of the hard disk are overwritten a number of times in order to enable reconstruction of the data. The application then finishes execution (step S61).

It can be seen from the description with reference to the flow diagram of FIG. 8 that the remote vault interface application includes an additional function upon termination of execution which enables the cleaning of the temporary computer. This allows a user who has downloaded the code to clean the computer to remove all traces of the application and files downloaded by the application to avoid the code or the files falling into the hands of unauthorized personnel.

In this embodiment of the present invention the vault interface provided by the remote vault interface application is the same as that provided by the secure storage application. Thus this provides a user with the same degree of functionality on a temporary computer as on their normal computer. However, the present invention is not limited to the same degree of functionality and the vault interface functionality provided by the downloaded code can be more limited. For example, it may only allow the downloading of files and not the uploading, deletion of moving of files within the vault. Thus this would merely provide a means by which files could be read from the secure storage area.

FIG. 9 is a schematic diagram of the user's temporary computer 4 after installation of the remote vault interface application code. The user's temporary computer 4 is provided with a network interface 40 which can comprise a network card, or a modem, for example. A hard disk 48 is provided to store the application code, files used by the user, and application data files used by the application. A pointing device 43 such as a mouse, a display 41 and a keyboard 42 are provided to provide a means by which a user can interface to the computer. A data memory 46 which comprises volatile memories such as RAM stores data used by the application during execution. This data includes the user password, the server address data for accessing the FTP server, the vault data generating the vault interface, and the dialler data for connecting to the ISP. A program memory 45 is provided which comprises volatile memory such as RAM for storing the application code read from the hard disk 48 for execution by a processor 44. In this embodiment of the present invention the code comprises seven functional code modules. Six of the functional code modules are the same as for the code of the secure storage application, i.e. the interface code, dialler code, FTP code, encryption code, file manipulation code, and capacity meter code. The application code in the remote vault interface application includes a further functional module which comprises secure deletion code for performing secure deletion upon closure of the application as described hereinabove with reference to the flow diagram of FIG. 8.

The deletion function in this download code is important and can remove all traces of the application having been on the computer. Not only is it possible to delete the code and the files downloaded by the code, it is also possible for the application to delete files in the print spool if files have been printed. Thus the application can keep track of all operations performed on files downloaded by the code so that all traces of the code and operations performed by the code can be deleted from the computer.

Although the present invention has been described hereinabove with reference to a specific embodiment, it will be apparent to a skilled person in the art that modifications lie within the spirit and scope of the present invention.

For example, although the present invention has been described with reference to the inputting of a password by the user, it will be understood that this is not limited to the inputting of alphabetical characters. A password can comprise any numeric or alphabetical characters and any combination. The password can in fact comprise preferably a pass phrase which includes a longer string of characters to increase security.

What is claimed is:

1. A method of setting up a secure storage system, the method comprising:
setting up a storage area for storing encrypted files in a store accessible via the Internet, the files being encrypted using a password;
generating user specific user interface code requiring the entry of a user password during execution on a user's computer for access to the encrypted files in said store over the Internet; and
storing said user specific user interface code at a site accessible via the Internet for download by a user.

2. A method according to claim 1, wherein said user specific user interface code is generated to include information on the location of said storage area in said store to access said encrypted files over the Internet.

3. A method according to claim 1, wherein said storage area is set up to require user specific security data to allow access to said encrypted files, and said user specific user interface code is generated to include said user specific security data to allow said user specific user interface code when executed to access said storage area.

4. A method according to claim 1, wherein said user specific user interface code is generated to require the entry of said user password for said user specific interface code to execute on said user's computer to generate an interface to said storage area to allow access to said encrypted files.

5. A method according to claim 1, wherein said user password is said password.

6. A method according to claim 1, wherein said user specific user interface code is generated to allow the decryption of said encrypted files when executed on said user's computer.

7. A method according to claim 1, wherein said user specific user interface code is generated to allow for said encrypted files to be downloaded to said user's computer when executed on said user's computer.

8. A method according to claim 7, wherein said user specific user interface code is generated to allow for the automatic decryption of the downloaded encrypted files when executed on said user's computer.

9. A method according to claim 8, wherein said user specific user interface code is generated to allow a user to select to automatically decrypt the downloaded encrypted files when executed on said user's computer.

10. A method according to claim 1, wherein said user specific user interface code is generated to allow the automatic deletion of said user specific user interface code at the completion of execution on said user's computer.

11. A method according to claim 1, wherein said user specific user interface code is generated to allow the automatic deletion of any encrypted files downloaded to said user's computer at the completion of execution on said user's computer.

12. A method according to claim 10, wherein said user specific user interface code is generated to allow a user selection of whether or not to automatically delete at the completion of execution of said user specific user interface code on said user's computer.

13. A method according to claim 1, including setting up a web page in said storage area with a link to said user specific user interface code at said site to allow a user to download said user specific user interface code.

14. A method according to claim 1, wherein said storage area is of a predetermined size, and said user specific user interface code is generated to include an indication of the available capacity in said storage area when executed on said user's computer.

15. A method according to claim 14, wherein said user specific user interface code is generated to be able to monitor the size of files deleted from or uploaded to said storage area and to modify the indication of available capacity accordingly when executed on said user's computer.

16. A method according to claim 1, wherein said user specific user interface code is generated to allow for encrypted files to be uploaded to said storage area from said user's computer when said user specific user interface code executed on said user's computer.

17. A method according to claim 16, wherein said user specific user interface code is generated to be able to encrypt files using said user password before uploading to said storage area.

18. A method according to claim 17, wherein said user specific user interface code is generated to be able to detect whether files to be uploaded are encrypted or not and to encrypt files that are not encrypted automatically.

19. A method according to claim 1, including receiving user registration data for registration of a user for use of the secure storage system, wherein said storage area is set up and said user specific user interface code is generated in dependence upon said registration data.

20. A system for setting up a secure storage system, the system comprising:
set up means for setting up a storage area for storing encrypted files in a store accessible via the Internet, the files being encrypted using a password;
generating means for generating user specific user interface code requiring the entry of a user password during execution on a user's computer for access to the encrypted files in said store over the Internet; and
storing means for storing said user specific user interface code at a site accessible via the Internet for download by a user.

21. A system according to claim 20, wherein said generating means is adapted to generate said user specific user interface code to include information on the location of said storage area in said store to access said encrypted files over the Internet.

22. A system according to claim 20, wherein said set up means is adapted to set up said storage area to require user specific security data to allow access to said encrypted files, and said generating means is adapted to generate said user specific user interface code to include said user specific security data to allow said user specific user interface code when executed to access said storage area.

23. A system according to claim 20, wherein said generating means is adapted to generate said user specific user interface code to require the entry of said user password for said user specific interface code to execute on said user's computer to generate an interface to said storage area to allow access to said encrypted files.

24. A system according to claim 20, wherein said user password is said password.

25. A system according to claim 20, wherein said generating means is adapted to generate said user specific user interface code to allow the decryption of said encrypted files when executed on said user's computer.

26. A system according to claim 20, wherein said generating means is adapted to generate said user specific user interface code to allow for said encrypted files to be downloaded to said user's computer when executed on said user's computer.

27. A system according to claim 26, wherein said generating means is adapted to generate said user specific user interface code to allow for the automatic decryption of the downloaded encrypted files when executed on said user's computer.

28. A system according to claim 27, wherein said generating means is adapted to generate said user specific user interface code to allow a user to select to automatically decrypt the downloaded encrypted files when executed on said user's computer.

29. A system according to claim 20, wherein said generating means is adapted to generate said user specific user interface code to allow the automatic deletion of said user specific user interface code at the completion of execution on said user's computer.

30. A system according to claim 20, wherein said generating means is adapted to generate said user specific user interface code to allow the automatic deletion of any encrypted files downloaded to said user's computer at the completion of execution on said user's computer.

31. A system according to claim 29, wherein said generating means is adapted to generate said user specific user interface code to allow a user selection of whether or not to automatically delete at the completion of execution of said user specific user interface code on said user's computer

32. A system according to claim 20, wherein said set up means is adapted to set up a web page in said storage area with a link to said user specific user interface code at said site to allow a user to download said user specific user interface code.

33. A system according to claim 20, wherein said set up means is adapted to set up said storage area with a predetermined size, and said generating means is adapted to generate said user specific user interface code to include an indication of the available capacity in said storage area when executed on said user's computer.

34. A system according to claim 33, wherein said generating means is adapted to generate said user specific user interface code to be able to monitor the size of files deleted from or uploaded to said storage area and to modify the indication of available capacity accordingly when executed on said user's computer.

35. A system according to claim 20, wherein said generating means is adapted to generate said user specific user interface code to allow for encrypted files to be uploaded to said storage area from said user's computer when said user specific user interface code executed on said user's computer.

36. A system according to claim 35, wherein said generating means is adapted to generate said user specific user interface code to be able to encrypt files using said user password before uploading to said storage area.

37. A system according to claim 36, wherein said generating means is adapted to generate said user specific user interface code to be able to detect whether files to be uploaded are encrypted or not and to encrypt files that are not encrypted automatically.

38. A system according to claim 20, including receiving means for receiving user registration data for registration of a user for use of the secure storage system, wherein said set up means is adapted to set up said storage area in dependence upon said registration data, and said generating means is adapted to generate said user specific user interface code in dependence upon said registration data.

39. A computer system for setting up a secure storage system comprising:
a program memory containing processor readable instructions; and
a processor for reading and executing the instructions contained in the program memory;
wherein said processor readable instructions comprise instructions controlling the processor to carry out the method of any one of claims 1 to 19.

40. A carrier medium carrying computer readable instructions for controlling a computer to carry out the method of any one of claims 1 to 19.

41. A secure storage access method to allow secure access to encrypted files stored in a storage area accessible via the Internet, the method comprising:
storing user specific user interface code requiring the entry of a user password during execution on a user's computer for access to said encrypted files in said storage area over the Internet; and
downloading said user specific user interface code via the Internet to a user's computer upon request from said user's computer for execution of the code on said user's computer to allow a user to gain access to said encrypted files in said storage area over the Internet upon entry of said user password.

42. A secure storage access method according to claim 41, wherein said user specific user interface code includes information on the location of said storage area to access said encrypted files over the Internet.

43. A secure storage access method according to claim 41, wherein said storage area requires user specific security data to allow access to said encrypted files, and said user specific user interface code includes said user specific security data to allow said user specific user interface code when executed to access said storage area.

44. A secure storage access method according to claim 41, wherein said user specific user interface code requires the entry of said user password for said user specific interface code to execute on said user's computer to generate an interface to said storage area to allow access to said encrypted files.

45. A secure storage access method according to claim 41, wherein said files are encrypted with a password.

46. A secure storage access method according to claim 45, wherein said user password comprises said password.

47. A secure storage access method according to claim 41, wherein said user specific user interface code allows the decryption of said encrypted files when executed on said user's computer.

48. A secure storage access method according to claim 41, wherein said user specific user interface code allows for said encrypted files to be downloaded to said user's computer when executed on said user's computer.

49. A secure storage access method according to claim 48, wherein said user specific user interface code allows for the automatic decryption of the downloaded encrypted files when executed on said user's computer.

50. A secure storage access method according to claim 49, wherein said user specific user interface code allows a user to select to automatically decrypt the downloaded encrypted files when executed on said user's computer.

51. A secure storage access method according to claim 41, wherein said user specific user interface code allows the automatic deletion of said user specific user interface code at the completion of execution on said user's computer.

52. A secure storage access method according to claim 41, wherein said user specific user interface code allows the automatic deletion of any encrypted files downloaded to said user's computer at the completion of execution on said user's computer.

53. A secure storage access method according to claim 51, wherein said user specific user interface code allows a user to select whether or not to automatically delete at the completion of execution of said user specific user interface code on said user's computer

54. A secure storage access method according to claim 41, including storing a web page with a link to said user specific user interface code to allow a user to download said user specific user interface code.

55. A secure storage access method according to claim 41, wherein said storage area is of a predetermined size, and said user specific user interface code includes an indication of the available capacity in said storage area when executed on said user's computer.

56. A secure storage access method according to claim 55, wherein said user specific user interface code is able to monitor the size of files deleted from or uploaded to said storage area and to modify the indication of available capacity accordingly when executed on said user's computer.

57. A secure storage access method according to claim 41, wherein said user specific user interface code allows for encrypted files to be uploaded to said storage area from said user's computer when said user specific user interface code executed on said user's computer.

58. A secure storage access method according to claim 57, wherein said user specific user interface code is able to encrypt files using said user password before uploading to said storage area.

59. A secure storage access method according to claim 58, wherein said user specific user interface code is able to detect whether files to be uploaded are encrypted or not and to encrypt files that are not encrypted automatically.

60. A secure storage access system to allow secure access to encrypted files stored in a storage area accessible via the Internet, the system comprising:
storing means storing user specific user interface code requiring the entry of a user password during execution on a user's computer for access to said encrypted files in said storage area over the Internet; and
down loading means for down loading said user specific user interface code via the Internet to a user's computer upon request from said user's computer for execution of the code on said user's computer to allow a user to gain access to said encrypted files in said storage area over the Internet upon entry of said user password.

61. A secure storage access system according to claim 60, wherein said user specific user interface code includes information on the location of said storage area to access said encrypted files over the Internet.

62. A secure storage access system according to claim 60, wherein said storage area requires user specific security data to allow access to said encrypted files, and said user specific user interface code includes said user specific security data to allow said user specific user interface code when executed to access said storage area.

63. A secure storage access system according to claim 60, wherein said user specific user interface code requires the entry of said user password for said user specific interface code to execute on said user's computer to generate an interface to said storage area to allow access to said encrypted files.

64. A secure storage access system according to claim 60, wherein said files are encrypted with a password.

65. A secure storage access system according to claim 64, wherein said user password comprises said password.

66. A secure storage access system according to claim 60, wherein said user specific user interface code allows the decryption of said encrypted files when executed on said user's computer.

67. A secure storage access system according to claim 60, wherein said user specific user interface code allows for said encrypted files to be downloaded to said user's computer when executed on said user's computer.

68. A secure storage access system according to claim 67, wherein said user specific user interface code allows for the automatic decryption of the downloaded encrypted files when executed on said user's computer.

69. A secure storage access system according to claim 68, wherein said user specific user interface code allows a user to select to automatically decrypt the downloaded encrypted files when executed on said user's computer.

70. A secure storage access system according to claim 60, wherein said user specific user interface code allows the automatic deletion of said user specific user interface code at the completion of execution on said user's computer.

71. A secure storage access system according to claim 60, wherein said user specific user interface code allows the automatic deletion of any encrypted files downloaded to said user's computer at the completion of execution on said user's computer.

72. A secure storage access system according to claim 60, wherein said user specific user interface code allows a user to select whether or not to automatically delete at the completion of execution of said user specific user interface code on said user's computer

73. A secure storage access system according to claim 60, including web storing means storing a web page with a link to said user specific user interface code to allow a user to download said user specific user interface code.

74. A secure storage access system according to claim 60, wherein said storage area is of a predetermined size, and said user specific user interface code includes an indication of the available capacity in said storage area when executed on said user's computer.

75. A secure storage access system according to claim 74, wherein said user specific user interface code is able to monitor the size of files deleted from or uploaded to said storage area and to modify the indication of available capacity accordingly when executed on said user's computer.

76. A secure storage access system according to claim 60, wherein said user specific user interface code allows for encrypted files to be uploaded to said storage area from said user's computer when said user specific user interface code executed on said user's computer.

77. A secure storage access system according to claim 76, wherein said user specific user interface code is able to encrypt files using said user password before uploading to said storage area.

78. A secure storage access system according to claim 77, wherein said user specific user interface code is able to detect whether files to be uploaded are encrypted or not and to encrypt files that are not encrypted automatically.

79. A secure storage computer system to allow secure access to encrypted files stored in a storage area accessible via the Internet comprising:
a program memory containing processor readable instructions; and
a processor for reading and executing the instructions contained in the program memory;
wherein said processor readable instructions comprise instructions controlling the processor to carry out the method of any one of claims 41 to 78.

80. A carrier medium carrying computer readable instructions for controlling a computer to carry out the method of any one of claims 41 to 78.

81. A method of accessing encrypted files stored in a store accessible via the Internet, the method comprising:
down loading user specific user interface code from a site over the Internet to a user's computer; and
executing said user specific user interface code on said user's computer to require the input of a user password to allow access to the stored encrypted files via the Internet and to allow for the decryption of said encrypted files.

82. A method according to claim 81, wherein said user specific user interface code includes information on the location of said storage area in said store to access said encrypted files over the Internet and uses said information to access said storage area.

83. A method according to claim 81, wherein said storage area requires user specific security data to allow access to said encrypted files, and said user specific user interface code includes said user specific security data to allow said user specific user interface code when executed to access said storage area.

84. A method according to claim 81, wherein said user specific user interface code requires the entry of said user password for said user specific interface code to execute on said user's computer to generate an interface to said storage area to allow access to said encrypted files.

85. A method according to claim 81, wherein said encrypted files stored in said storage area are encrypted using a password.

86. A method according to claim 85, wherein said user password is said password.

87. A method according to claim 81, wherein said user specific user interface code allows the decryption of said encrypted files when executed on said user's computer.

88. A method according to claim 81, wherein said user specific user interface code allows for said encrypted files to be downloaded to said user's computer when executed on said user's computer.

89. A method according to claim 88, wherein said user specific user interface code allows for the automatic decryption of the downloaded encrypted files when executed on said user's computer.

90. A method according to claim 89, wherein said user specific user interface code allows a user to select to automatically decrypt the downloaded encrypted files when executed on said user's computer.

91. A method according to claim 81, wherein said user specific user interface code allows the automatic deletion of said user specific user interface code at the completion of execution on said user's computer.

92. A method according to claim 81, wherein said user specific user interface code allows the automatic deletion of any encrypted files downloaded to said user's computer at the completion of execution on said user's computer.

93. A method according to claim 91, wherein said user specific user interface code allows a user selection of whether or not to automatically delete at the completion of execution of said user specific user interface code on said user's computer.

94. A method according to claim 81, wherein said storage area is of a predetermined size, and said user specific user interface code includes an indication of the available capacity in said storage area when executed on said user's computer.

95. A method according to claim 94, wherein said user specific user interface code monitors the size of files deleted from or uploaded to said storage area and to modifies the indication of available capacity accordingly when executed on said user's computer.

96. A method according to claim 81, wherein said user specific user interface code allows for encrypted files to be uploaded to said storage area from said user's computer when said user specific user interface code executed on said user's computer.

97. A method according to claim 96, wherein said user specific user interface code is able to encrypt files using said user password before uploading to said storage area.

98. A method according to claim 97, wherein said user specific user interface code is able to detect whether files to be uploaded are encrypted or not and to encrypt files that are not encrypted automatically.

99. Apparatus for accessing encrypted files stored in a store accessible via the Internet, the apparatus comprising:
down loading means for down loading user specific user interface code from a site over the Internet; and
processing means for executing said user specific user interface code to require the input of a user password to allow access to the stored encrypted files via the Internet and to allow for the decryption of said encrypted files.

100. Apparatus according to claim 99, wherein said user specific user interface code includes information on the location of said storage area in said store to access said encrypted files over the Internet and said processing means is adapted to use said information to access said storage area.

101. Apparatus according to claim 99, wherein said storage area requires user specific security data to allow access to said encrypted files, said user specific user interface code includes said user specific security data, and said processing means is adapted to use said specific security data to access said storage area.

102. Apparatus according to claim 99, wherein said processing means is adapted to execute said user specific user interface code to require the entry of said user password for said user specific interface code to execute to generate an interface to said storage area to allow access to said encrypted files.

103. Apparatus according to claim 99, wherein said encrypted files stored in said storage area are encrypted using a password.

104. Apparatus according to claim 103, wherein said user password is said password.

105. Apparatus according to claim 99, wherein said processing means is adapted to execute said user specific user interface code to allow the decryption of said encrypted files.

106. Apparatus according to claim 99, wherein said processing means is adapted to execute said user specific user interface code to allow for said encrypted files to be downloaded.

107. Apparatus according to claim 106, wherein said processing means is adapted to execute said user specific user interface code to automatically decrypt the downloaded encrypted files.

108. Apparatus according to claim 107, wherein said processing means is adapted to execute said user specific user interface code to allow a user to select to automatically decrypt the downloaded encrypted files.

109. Apparatus according to claim 99, wherein said processing means is adapted to execute said user specific user interface code to automatically delete said user specific user interface code at the completion of execution.

110. Apparatus according to claim 99, wherein said processing means is adapted to execute said user specific user interface code to automatically delete any encrypted files downloaded at the completion of execution.

111. Apparatus according to claim 109, wherein said processing means is adapted to execute said user specific user interface code to allow a user selection of whether or not to automatically delete at the completion of execution of said user specific user interface code.

112. Apparatus according to claim 99, wherein said storage area is of a predetermined size, and said processing means is adapted to execute said user specific user interface code to include an indication of the available capacity in said storage area.

113. Apparatus according to claim 112, wherein said processing means is adapted to execute said user specific user interface code to monitor the size of files deleted from or uploaded to said storage area and to modify the indication of available capacity accordingly.

114. Apparatus according to claim 99, wherein said processing means is adapted to execute said user specific user interface code to upload encrypted files to said storage area.

115. Apparatus according to claim 114, wherein said processing means is adapted to execute said user specific user interface code to encrypt files using said user password before uploading to said storage area.

116. Apparatus according to claim 115, wherein said processing means is adapted to execute said user specific user interface code to detect whether files to be uploaded are encrypted or not and to encrypt files that are not encrypted automatically.

117. Computer apparatus for accessing encrypted files stored in a store accessible via the Internet, the apparatus comprising:
a program memory containing processor readable instructions; and
a processor for reading and executing the instructions contained in the program memory;
wherein said processor readable instructions comprise instructions controlling the processor to carry out the method of any one of claims 81 to 98.

118. A carrier medium carrying computer readable instructions for controlling a computer to carry out the method of any one of claims 81 to 98.
